(19) United States
(12) Patent Application Publication
(10) Pub. No.: US 2005/0219149 A1
(43) Pub. Date: Oct. 6, 2005

(54) Device for reconstructing a graphical message

(76) Inventors: Pim Theo Tuyls, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,252

(22) PCT Filed: Mar. 20, 2003
(86) PCT No.: PCT/IB03/01151

§ 371 Date: Oct. 5, 2004

(30) Foreign Application Priority Data
Apr. 8, 2002 (EP) 02076401.5

(51) Int. Cl. G09G 5/00

(52) U.S. Cl. 345/4

(57) ABSTRACT

A device comprising receiving means for receiving a sequence of information units, a first display arranged for displaying the sequence of information units by activating cells in a first electro-optical layer in dependence on the sequence, a second display arranged for activating cells in a second electro-optical layer in dependence on elements in a key sequence, in which the first and second displays are arranged to be superimposed on each other, and in which one of the first and second displays comprises a light valve, and the other of the first and second displays comprises one of: a transmissive display, an emissive display, a reflective display and a transflective display.

The invention relates to a device for reconstructing a graphical message.

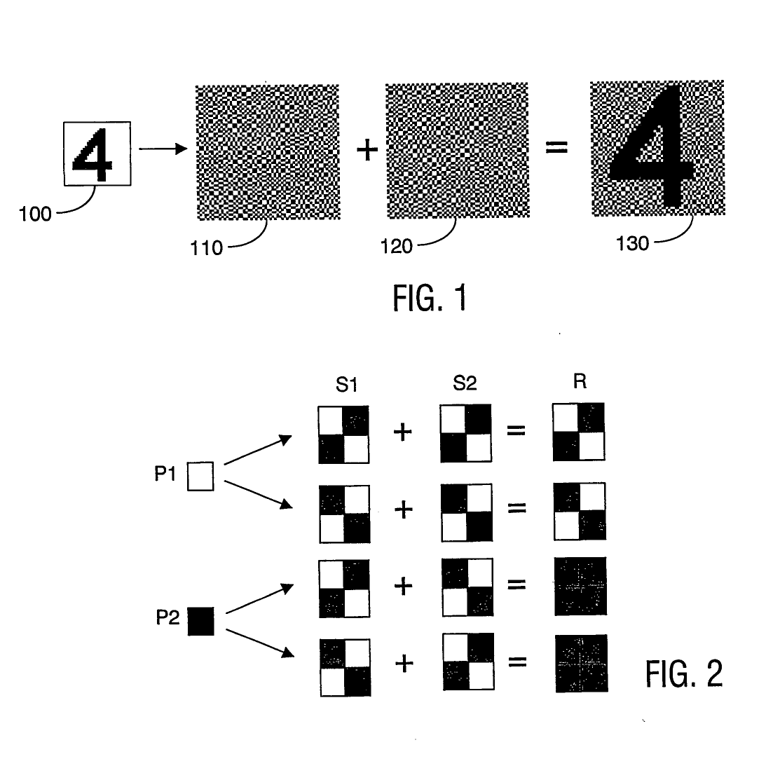

Visual cryptography (M. Naor, A. Shamir: Visual Cryptology, Eurocrypt '94, Springer-Verlag LNCS Vol. 950, Springer-Verlag, 1995, pp 1-12) can briefly be described as follows. An image is split into two randomized parts, the image plus a randomization and the randomization itself. Either part contains no information on the original image because of the randomization. However, when both parts are physically overlaid the original image is reconstructed. An example is given in FIG. 1: original image 100 is split into shares 110 and 120, which when overlaid result in reconstructed image 130.

If the two parts do not fit together, no information on the original image is revealed and a random image is produced. Therefore if two parties want to communicate using visual cryptography, they have to share the randomization. A basic implementation would be to give a receiving party a transparency containing the randomization. The sender would then use this randomization to randomize the original message, and transmits the randomized message to the receiver, on a transparency or by any other means. The receiver puts the two transparencies on top of each other and recovers the message. This, scheme can be compared to a one-time pad.

A more flexible implementation is obtained when using two display screens, e.g. two LCD screens. A first liquid crystal display renders the image plus randomization and a second LCD displays the randomization itself. If the screens are put on top of each other, the reconstructed image appears.

FIG. 2 illustrates the visual cryptography process as devised by Naor and Shamir in the above-referenced paper. The process is illustrated here for a single pixel, but of course every pixel in the source image is to be processed in this way.

Every pixel of the original image 100 is translated to four sub-pixels. To generate the first share S1 for this pixel, two of the four pixels are randomly chosen to be black (non-transparent) while the other two are chosen to be white (transparent). To generate the other share S2 of this pixel the four sub-pixels are copied if the corresponding pixel in the original image was white and they are inverted if the original pixel was black. For each pixel a new random choice of which two of the four pixels should be black (non-transparent) needs to be made. The number of sub-pixels into which the pixels are split can be chosen arbitrarily, but should be at least two.

This way, two collections of sub-pixels are formed. These collections make up the two shares. Neither of the shares gives any information on the color of the original pixel. In all cases, some of the sub-pixels chosen to represent the original pixel in either of the shares are black and the rest is white. Further, all possible combinations of black and white are equally likely to occur, since the random choice is made with a probability of p=0.5, independently for each pixel.

To reconstruct the original image, the two shares S1 and S2 are to be superimposed, i.e. put on top of each other. This is shown in the last column (R) of FIG. 2. If the original pixel were black (P2), then the superposition of the sub-pixels from shares S1 and S2 will result in four black sub-pixels. If the original pixel where white (P1), then the superposition of the sub-pixels from shares S1 and S2 will result in a black and white pattern in the reconstructed image 130, which often appears to be gray when seen from a distance.

If the two parts do not fit together no information on the original image is revealed and a random image is produced. Without knowing both of the shares, the probability that one set of sub-pixels corresponds to a white pixel in the original image 100 is equal to the probability that that set corresponds to a black pixel in the original image 100.

It is clear that the above scheme suffers from several disadvantages. First, in order to show the same level of detail in the reconstructed image 130, the shares 110, 120 require a four times higher resolution than the original image 100. This makes the reconstructed image 130 four times as large as the original image 100.

Further, the contrast and brightness of the reconstructed image 130 is severely reduced compared to the contrast and brightness of the original image 100. This is due to the fact that white pixels in the original image 100 turn into a pattern of black and white pixels in the reconstructed image 130. This also causes a small distortion at the edges of the parts that were black in the original image 100. These effects can be seen clearly in FIG. 1.

European patent application 02075178.0 (attorney docket PHNL020050) by the same applicant as the present application provides a method and device for reconstructing a graphical message. After receiving the sequence of information units, preferably a sequence of binary values, the device renders the sequence on a first display, without performing any processing or decrypting steps before any displaying takes place. The information units are displayed as they are received. On a second display another pattern is displayed, which is generated based entirely on a key sequence. This European patent application is incorporated by reference in the present application.

Reconstruction of the image is performed by superimposing the first and second displays in the correct alignment, so that the user can see the reconstructed graphical message. The reconstruction is performed directly by the human eye and not by a device which might be compromised. This makes the use of visual cryptography to communicate secret information more secure.

The prior art visual cryptography systems, as explained above, rely upon the use of polarized light to maintain the sharpness and clarity of the original image in the reconstruction. However, the use of polarized light seriously decreases the brightness of a display, by about 50%. Furthermore, the above mentioned prior art visual cryptography system requires that (at least a portion of) the panels are in direct contact without an intermediate polarizer being present. As a consequence, such panels or screens (for reasons of convenience hereafter called “displays”) must be customized for cryptography use.

It is an object of the present invention to provide a device for use with visual cryptographic applications which is more effective and provides a display with on the average more brightness than the above-mentioned displays when used with visual cryptographic applications.

This object is achieved according to the invention in a device as claimed in claim 1. These displays are easy and cheap to implement, do not require customization, do not rely upon polarized light and due to the combination of light valve and transmissive, emissive, reflective or transflective display produce on the average a brighter reconstructed image than the prior art.

If one of the displays is embodied as a reflective display, it is preferably realized as a combination of a light source and one of: a liquid crystal display, an electrochromic display, an electromechanical display, an electrowetting display and an electrophoretic display, or as a hybrid mirror, as described in international patent application PCT/IB01/02516 (attorney docket PHNL010007) by the same applicant as the present application.

A color filter or other color rendering method (such as providing the display pixels themselves with intrinsic color) can be provided in the display to have the reconstructed image appear in any desired color. Various other advantageous embodiments are set out in the dependent claims.

These and other aspects of the invention will be apparent from and elucidated with reference to the embodiments shown in the drawings, in which:

FIG. 1 shows an original image, two shares obtained by visually encrypting the original image and a reconstructed image obtained by superimposing the two shares;

FIG. 2 illustrates the visual cryptography process as devised by Naor and Shamir in the above-referenced paper;

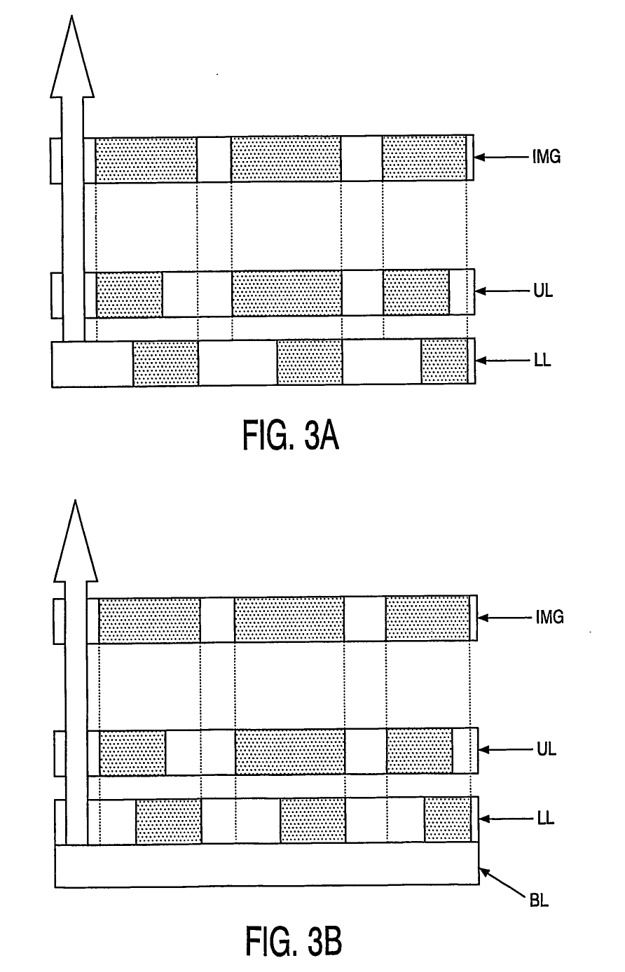

FIGS. 3A, 3B, 4, 5A and 5B illustrate various embodiments of a device capable of reconstructing a visually encrypted message;

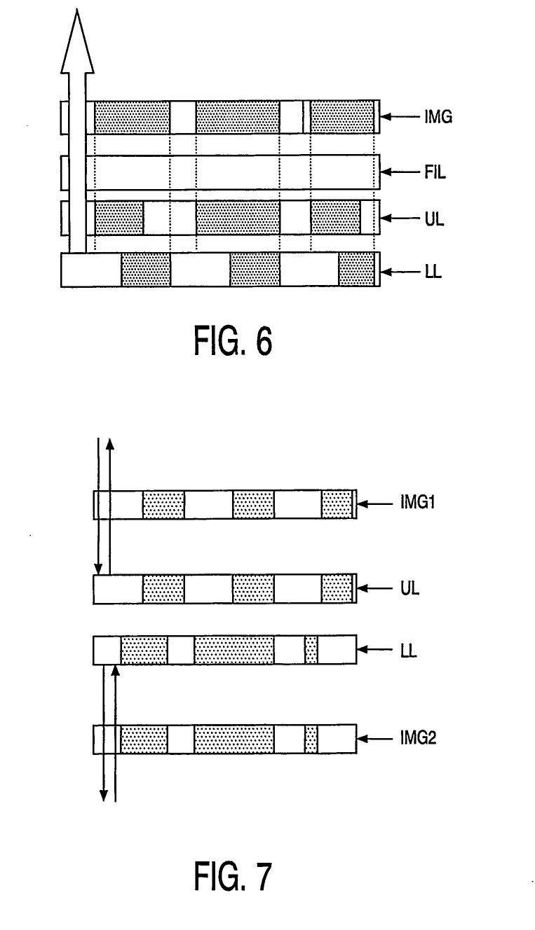

FIG. 6 illustrates a variant on any of these embodiments in which a color filter is provided; and

FIG. 7 illustrates how the two displays in the device can additionally be used to present two separate images to a user.

Throughout the figures, the same reference numerals indicate similar or corresponding features. Some of the features indicated in the drawings are typically implemented in software, and as such represent software entities, such as software modules or objects.

The above-mentioned European patent application 02075178.0 (attorney docket PHNL020050) extensively describes the basic construction of a device comprising receiving means for receiving a sequence of information units, a first display arranged for displaying the sequence of information units by activating cells in a first electro-optical layer in dependence on the sequence, a second display arranged for activating cells in a second electro-optical layer in dependence on elements in a key sequence, in which the first and second displays are arranged to be superimposed on each other. For reasons of brevity, this description is not repeated here. The present invention provides various advantageous embodiments of the first and second displays of that device.

In general, the device according to the invention comprises two matrix displays with respective electro-optical layers. The first layer displays the sequence as it is received from a server. The second layer displays a pattern based on a key sequence, for example by generating a pseudo-random bit sequence using the key sequence as a seed to initialize a pseudo-random number generator (PRNG). Cells in the second display are then activated (e.g. a sufficient voltage is applied to them) in dependence on the pseudo-random bit sequence.

When the first and second displays are subsequently superimposed on each other, the message is visually reconstructed. Because both displays each effectively display one share of a visually encrypted image, the user can now observe the reconstructed image representing the message.

Preferably the second display is embodied in a unit physically separable from the first display, and provided with a memory for storing the key sequence. If the key sequence is used in conjunction with a PRNG, or as input for a symmetric cipher or other technique to generate a bit sequence from which the pattern can be reconstructed, then also a processor is necessary in the unit. The unit can then be placed on top of the display in a host device, or inserted in a slot in the host device to superimpose the two displays. The separable unit can in principle be considerably smaller than the first display, significantly reducing the cost of constructing this unit.

No electrical, optical or other communication paths between the first and second displays, or the unit and host device in which they are embodied, should exist. As the patterns and the key sequence are provided in digital (electronic) form, any such communication paths could potentially be abused by an attacker to obtain patterns and/or key sequence.

In FIG. 3A, the lower layer LL comprises an emissive display, e.g. Polymer-LED, an OLED, a field emission display or a CRT. The upper layer UL comprises a light valve with transparent material which can be either made absorbing, reflecting or scattering. Light valves are matrix displays which spatially modulate the transmission of incident light. Some examples are LCDs, electrophoretic displays, electrochromic displays, electrowetting displays and hybrid mirrors when operating in a mode between transparent and either absorbing, reflecting or scattering optical states.

By superimposing the upper layer UL (the separable unit) on the lower layer LL (the host device) the two complementary patterns produced by the respective displays are combined and the original image IMG is reconstructed. FIG. 3B is a variant of the embodiment of FIG. 3A, in which the lower layer LL is a light valve with an external light source.

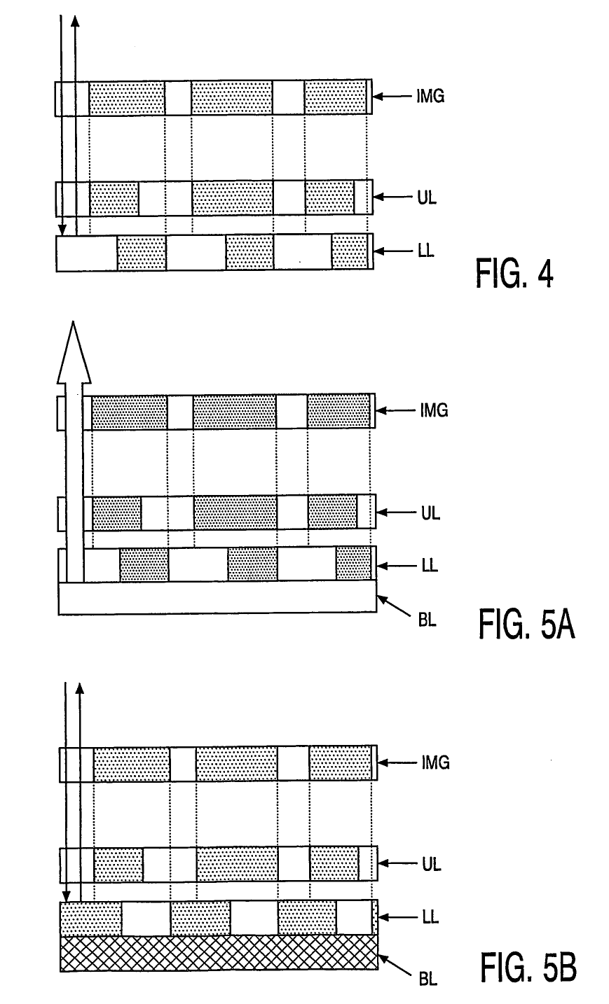

In FIG. 4 another embodiment is shown, wherein the upper layer UL comprises a light valve display, and the lower layer comprises an intrinsically reflective display such as electrophoretic displays, PDLC or guest-host materials. Other display types may also comprise a reflective component to facilitate the reflection. Examples are LCDs, electrochromic displays, electrowetting displays and hybrid mirrors, which could be used when operating in a mode between reflective or scattering and absorbing or transmitting optical states. The lower layer is now used to reflect the incoming light at certain pixels and to transmit or absorb it at others.

In this embodiment, the lower layer LL is provided in the separate unit mentioned above on which the pattern represented by the key sequence is displayed. In case the lower layer LL is bi-stable, then it can be driven at a very low power and is therefore very well suited for small devices. This way the separate unit only has very modest power requirements. Preferably the host device is provided with a slot in which the unit can be inserted. This makes properly positioning the upper and lower layers very easy for a user.

FIGS. 5A-B show yet another embodiment, in which the upper layer UL is a light valve display, and the lower layer LL is a transflective display. Again, the lower layer LL is provided in the unit, and the upper layer UL is provided in the host device.

This embodiment can be used in both a reflective or a transmissive mode. The lower layer LL is made of transparent material which can be either made absorbing, reflecting or scattering. Examples are electrophoretic displays, PDLC, guest-host materials. In reflective mode, the lower layer is used to reflect the incoming light at certain parts (typically pixels) and to absorb or scatter it at others. In the transmissive mode the lower layer is used to transmit the light from a backlight BL at certain pixels and to absorb, scatter or reflect it at others.

In FIG. 5A the backlight BL has been activated, and the lower layer LL is now used in its transmissive mode. In FIG. 5B the backlight BL is not activated, which means that the lower layer LL is used in the reflective mode.

Any of the above embodiments can be enhanced with a color filter, to have the resulting image IMG appear in any desired color. FIG. 6 illustrates a variation of the embodiment of FIG. 3A in which a color filter FIL has been installed directly above the upper layer UL. It will be evident that this variation can equally well be applied to any of the other embodiments. The color filter FIL could also be provided between the upper layer UL and the lower layer LL. Alternatively, both displays can be provided with color filters.

It is worth noting that a combination of for example an upper layer UL switching between scattering and transmissive mode, and a lower layer LL switching between reflective and absorbing mode provides an additional benefit, as illustrated in FIG. 7. The two displays can now independently be used to generate images which can be viewed from two sides. One image IMG1 appears on one side of the device, but at the same time another image IMG2 appears on another side of the device.

An important application for such displays are telephones where the display flips open. Either of the layers UL and LL can be positioned to be at the outside when the display is closed. This way, a message such as “There is a visually encrypted message waiting for you” could be shown on this “outside” layer as image IMG1 or IMG2 so that the user can see it. He can then choose to flip open the display and switch the device to cryptographic mode. In this mode, the lower layer LL displays the patterns depending on the key sequence, and the upper layer UL displays the patterns depending on the received sequence (or vice versa). The user can then see the reconstructed image IMG, in a manner similar to that shown in FIG. 4.

The invention can be used to transmit a wide variety of messages from server to the device. For example, sensitive information like a bank balance, a private e-mail message, a new PIN code or password can be provided securely to the operator of the device.

One particularly useful application is to securely allow composition of a message by the operator of the device. In this embodiment, the reconstructed message represents a plurality of input means such as keys on a keyboard. Each input means represents an input word that can be used in the message that will be composed by the user. Such keys could be visually rendered as keys representing different alphanumerical characters, or as buttons representing choices like ‘Yes’, ‘No’, ‘More information’ and so on. Next to keys, the input means could also be checkboxes, selection lists, sliders or other elements typically used in user interfaces to facilitate user input.

The user now applies pressure to a particular spot of a touch-sensitive layer provided near or in the upper layer UL to select particular input means. The device then derives a set of coordinates at which pressure was applied, and sends this set of coordinates to the server. The device cannot learn which input means were selected, as this can only be found out when the reconstructed image is available. And because visual cryptography is used, the reconstructed image is only visible to the user, not stored anywhere in the device.

The invention can be used in any kind of device in which a secure communication from a server to a client device and/or vice versa is necessary. The device can be embodied as a personal computer, laptop, mobile phone, palmtop computer, automated teller machine, public Internet access terminal, or in fact any client device that is not completely trusted by its user to not contain any malicious software or hardware.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A device comprising receiving means for receiving a sequence of information units, a first display arranged for displaying the sequence of information units by activating cells in a first electro-optical layer in dependence on the sequence, a second display arranged for activating cells in a second electro-optical layer in dependence on elements in a key sequence, in which the first and second displays are arranged to be superimposed on each other, and in which
one of the first and second displays comprises a light valve,
and the other of the first and second displays comprises one of: a transmissive display, an emissive display, a reflective display and a transflective display.

2. The device of claim 1, in which the other display comprises a combination of a light source and one of: a liquid crystal display, an electrochromic display, an electromechanical display, an electrowetting display, an electrophoretic display and a hybrid mirror.

3. The device of claim 1, further comprising a color filter superimposed on at least one of the first and second displays.

4. The device of claim 1, further comprising a touch-sensitive layer, using which input representing a set of coordinates can be received from a user, and transmitting means for transmitting the received input to a server.

5. The device of claim 1, in which the second display is embodied in a unit physically separable from the first display, and provided with a memory for storing the key sequence.

6. The device of claim 5, in which the unit further comprises a processor for generating a pseudo-random stream of bits in dependence on a portion of the key sequence, the second display being arranged for activating the cells in the second electro-optical layer in dependence on the stream of bits.

7. The device of claim 5, in which the device further comprises a slot in which the unit can be inserted.
